(19) United States
(12) Patent Application Publication
(10) Pub. No.: US 2025/0144815 A1
(43) Pub. Date: May 8, 2025

(54) DRILL PIPE HANDLER AND ASSOCIATED METHOD OF HANDLING DRILL PIPE SEGMENTS

(71) Applicant: 9417-2491 QUEBEC INC., Shawinigan (CA)

(72) Inventor: Israël CORMIER, Beaumont (CA)

(21) Appl. No.: 18/941,475

(22) Filed: Nov. 8, 2024

(30) Foreign Application Priority Data
Nov. 8, 2023 (CA) 3219420

(51) Int. Cl. B25J 15/00; E21B 19/00

(52) U.S. Cl. CPC B25J 15/0038; E21B 19/00

(57) ABSTRACT

The drill pipe handler can have a core frame; a drill string axis; a first gripper assembly mounted to the core frame, the first gripper assembly having a first pair of jaws, the jaws of the first pair being opposed to one another, on opposite sides of the drill string axis; and a second gripper assembly mounted to the core frame, the second gripper assembly having a second pair of jaws, the jaws of the second pair being opposed to one another, on opposite sides of the drill string axis, the jaws of the second pair being spaced apart from the jaws of the first pair along the drill string axis, the second pair of jaws being pivotable as a whole around the drill string axis, relative the first pair of jaws.

### BACKGROUND

Drilling rigs are used in various industries, including construction, where drilling rigs are used for piling, civil engineering, where drilling is used for drilling wells, and the oil and gas industry where land drills are used to drill oil or gas wells. Drilling rigs can drill vertically, horizontally, or obliquely, and some drilling rigs are adaptable to drilling at different angles. Drilling technology bears similarities across industries. A typical drilling rig aims to drill a bore into the earth crust along a distance so long that it would not be feasible to provide a drill string made of a single component. In practice, common drilling distances are achieved by sequentially adding segments of drill pipe having manageable dimensions (e.g., between 10 and 20 feet) in the drill string, until the drill string reaches a length corresponding to the intended drilling distance. Drill pipe segments are typically generally elongated and cylindrical in shape, and can be tubular or solid. During drilling, the drill string is rotated along a drill string rotation axis which coincides with the central axis of the drill pipe segments which form the drill string, the central axis associated to the cylindrical shape of the segments. Drill pipe of different diameters exists, and while drill strings are often assembled of drill pipe segments of a same diameter, in some applications a drill string can be assembled with drill pipe segments having more than a single diameter.

Drill pipe segments are typically assembled to one another by male/female thread engagement, with additional drill pipe segments being sequentially threaded onto the free end of the drill string (the end of the drill string which is being manipulated by the equipment and which typically remains outside the earth crust). In some embodiments, the drill pipe segments are disassembled from one another after the drilling operation.

Over the last decades, there has been an increasing motivation to reduce human intervention in the handling of drilling equipment. These motivations sometimes find their source in the desire to reduce costs associated to human resources, and sometimes find their source in a desire to reduce the likelihood of injury. Indeed, while drill pipe segments can be more manageable that the drill string in its entirety, there can remain a motivation to keep them relatively long which can make them heavy and cumbersome to manipulate by hand. While existing drilling equipment addressed some of the needs and was satisfactory to a certain degree, there always remains room for improvement.

### SUMMARY

In particular, there remained a need to provide suitable handling of drill pipe segments in at least in some contexts of use. For instance, there remained a need for drill pipe handling equipment which included not only a gripping function, optionally a relative rotation function for threading or unthreading (screwing or unscrewing) drill pipe segments to or from a drill string, but also a torsioning function. Indeed, when disassembling drill pipe segments from a drill string, it is relatively common that the drill pipe segment to remove is frictionally engaged, e.g., friction-fitted, with the next drill pipe segment in the drill string. Indeed, while a limited amount of torsional force may be applied when assembling the drill pipe segments to one another into the drill string, the operation of the drill string itself leads to the presence of torsional forces along the drill string, and other factors such as vibrations and the like, may lead to a significant level of frictional engagement between adjacent drill pipe segments. In other words, adjacent drill pipe segments are often jammed with one another. A certain amount of torsional force may initially need to be applied between the two adjacent drill pipe segments to overcome this static friction before the last drill pipe segment can begin to rotate relative the second-to-last one and to the remainder of the drill string. Once the static friction has been overcome, a significantly lesser amount of torsional force than the one initially applied may be used to continue unscrewing the drill pipe segment from the drill string. The higher, initial application of torsional force may not need to be sustained along very large displacement before a lower torsional force can be used to finish the disassembly, and may need to be sustained only along a fraction of a rotation. A much larger amount of angular displacement may be used, at a significantly lower force, to perform the task of fully unscrewing the last drill pipe segment from the remainder of the drill string once the initial (static) friction fit has been overcome and before being able to remove it from the drill string.

In accordance with one aspect, there is provided a drill pipe segment handling system having a first gripper and a second gripper, where the first and second grippers can be activated not only to open and close for releasing and gripping a corresponding first and second drill pipe segments along a common drill string axis, respectively, but further to apply torsional force between the first drill pipe segment and the second drill pipe segment, of an amplitude suitable to overcome typical levels of static friction between the first and second drill pipe segments which may occur during disassembly.

In accordance with one aspect, there is provided a drill pipe handler comprising: a core frame; a drill string axis; a first gripper assembly mounted to the core frame, the first gripper assembly having a first pair of jaws, the jaws of the first pair being opposed to one another, on opposite sides of the drill string axis; and a second gripper assembly mounted to the core frame, the second gripper assembly having a second pair of jaws, the jaws of the second pair being opposed to one another, on opposite sides of the drill string axis, the jaws of the second pair being spaced apart from the jaws of the first pair along the drill string axis, the second pair of jaws being pivotable as a whole around the drill string axis, relative the first pair of jaws.

Many further features and combinations thereof concerning the present improvements will appear to those skilled in the art following a reading of the instant disclosure.

### DESCRIPTION OF THE FIGURES

In the figures,

FIG. 1 is an oblique view of an example of a drill pipe handler coupled to machinery, ready to perform a drill pipe segment handling task in accordance with an embodiment;

FIG. 2 is an oblique view of the example drill pipe handler;

FIGS. 3A, 3B and 3C are oblique views of a core frame, a first gripper assembly, and a second gripper assembly of the drill pipe handler;

FIG. 4A presents an example configuration of the drill pipe handler where the second gripper assembly is closed onto a corresponding drill pipe segment and the first gripper assembly is open;

FIG. 4B presents an example configuration of the drill pipe handler where both the first gripper assembly and the second gripper assembly are closed onto corresponding drill pipe segments and where the second gripper assembly is pivoted relative the first gripper assembly;

FIG. 5A is a cross-sectional view taken along lines 5A-5A of FIG. 3B, showing the first gripper assembly gripping a drill pipe segment having a first diameter;

FIG. 5B is a cross-sectional view similar to FIG. 5A, showing the first gripper assembly gripping a drill pipe segment having a second diameter;

FIG. 6 is a cross-sectional view taken along lines 6-6 of FIG. 2;

FIG. 7 is an oblique view of a support for the drill pipe handler; and

FIG. 8 is an oblique view of the drill pipe handler loaded onto the support and being moved via the support by a forklift.

### DETAILED DESCRIPTION

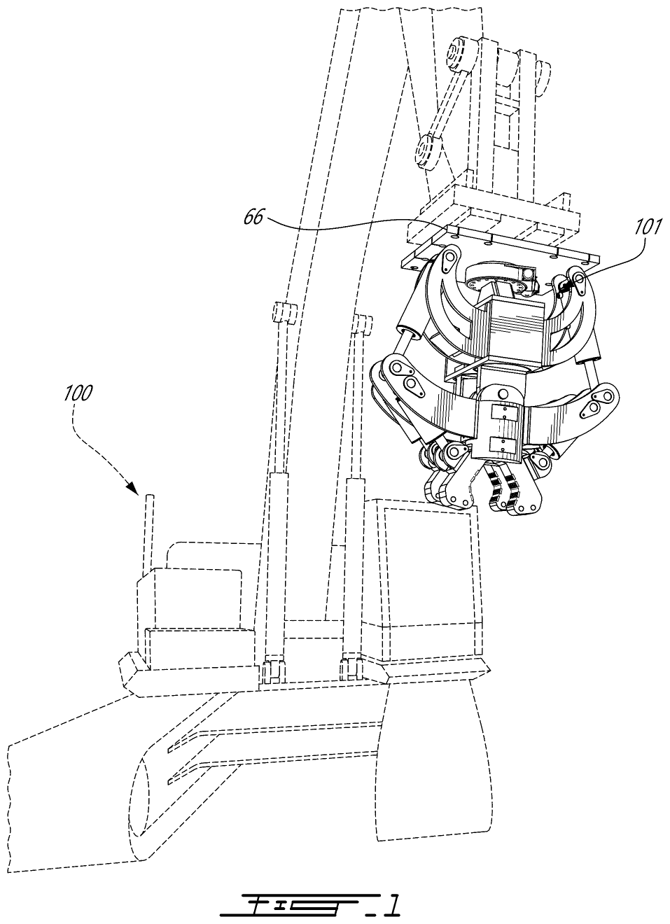

FIG. 1 shows an example of a drill pipe handler 10. In this example, the drill pipe handler 10 is configured for being manipulated by machinery 100. More specifically, in this example, the machinery 100 handling the drill pipe handler is an excavator, to which the drill pipe handler 10 is coupled to in lieu of a bucket. It will be understood that this is but one example and that in an alternate embodiment, the drill pipe handler 10 can be adapted for use with other types of machinery than an excavator.

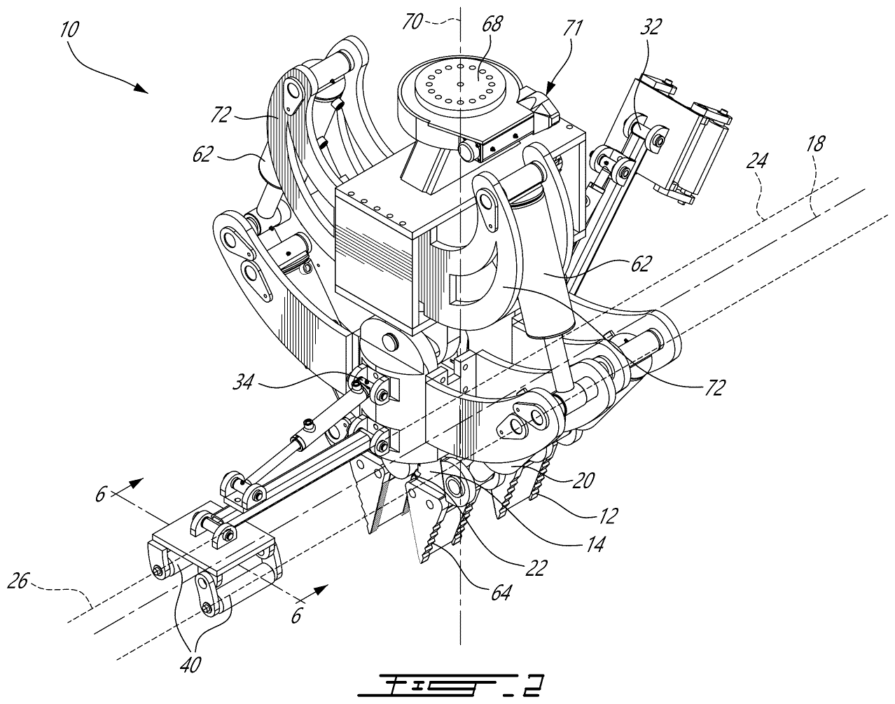

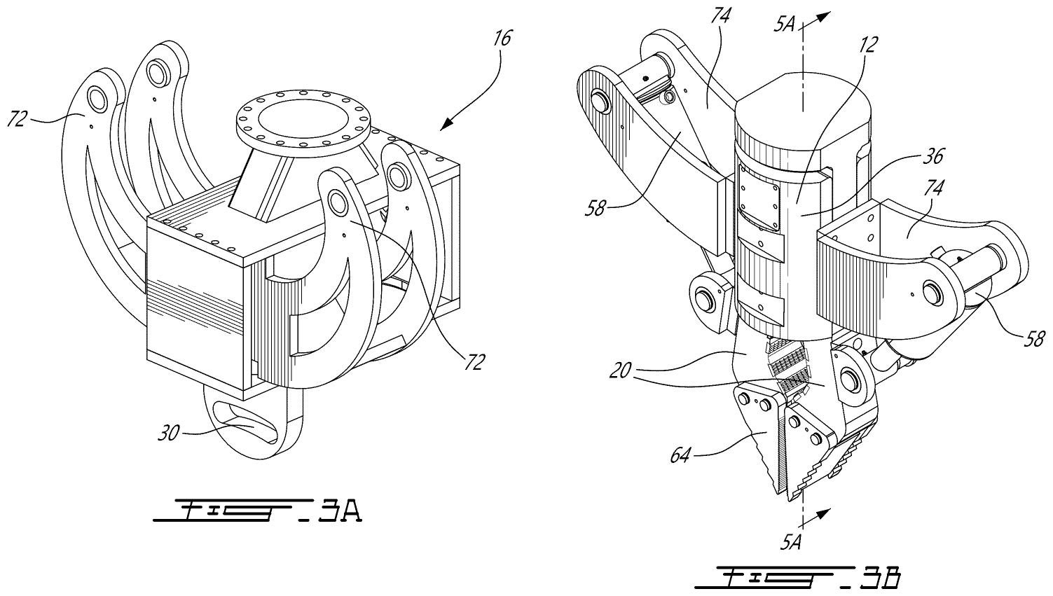

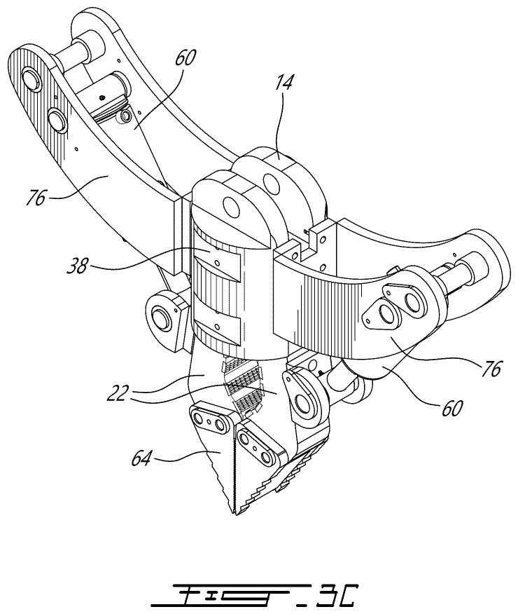

FIG. 2 shows the a portion of the drill pipe handler 10 alone, providing further detail than FIG. 1. The drill pipe handler 10 can be seen to generally have two independent gripper assemblies 12, 14 which will arbitrarily be referred to herein as a first gripper assembly 12 and a second gripper assembly 14 for ease of reference. Both of these gripper assemblies 12, 14 have similarities in that the each have a corresponding pair of jaws 20, 22 (better seen in FIGS. 3B and 3C), the jaws of each pair 20, 22 are opposed to one another. Each pair of jaws 20, 22 is closable and openable independently from the other pair of jaws 20, 22 for respectively gripping and releasing a corresponding pipe segment.

The drill pipe handler 10 has a structural component to which both gripper assemblies 12, 14 are mounted to. The structural component will be referred to herein as the core frame 16. In one mode of operation, the drill pipe handler 10 is moved in position and orientation in order to adapt to the orientation of a drill string. Accordingly, a virtual reference can be introduced: the drill string axis 18. The drill string axis 18 can be defined in a fixed position and orientation relative the core frame 16, and as such, the drill string axis 18 moves in position and/or orientation when the core frame 16 is moved in position and/or orientation. Such movements can be imparted by the machinery 100 for instance. More specifically, when moving the drill pipe handler 10 to handle drill pipe segments of a given drill string, the position and orientation of the core frame 16, and thus of the drill string axis 18 can be changed by moving the drill pipe handler 10 as a whole with the objective of orienting and positioning the drill string axis 18 in a manner to coincide with the rotation axis of the drill string, the latter rotation axis of the drill string remaining fixed in relation with the earth crust independently of any movement of the drill pipe handler 10 or core frame 16. The jaws of each pair of jaws 20, 22 are opposed to one another, on opposite sides of the drill string axis 18 and the two pairs of jaws 20, 22 are spaced apart from one another along the drill string axis 18.

Accordingly, while the core frame 16 of the drill pipe handler 10 can be moved in orientation and position, the pairs of jaws 20, 22 which are mounted to the core frame 16 both i) move together with the core frame 16 and ii) open or close independently from one another. The pairs of jaws 20, 22 are mounted to the core frame 16, in a position which allows them to operate on drill pipe segments 24, 26 which are aligned with the drill string axis 18. In one mode of operation, the first pair of jaws 20 can be closed onto a first drill pipe segment 24 which forms part of the drill string, whereas the second pair of jaws 22 can be closed onto a second drill pipe segment 26 which is to be threadingly engaged with or threadingly disengaged from the first drill pipe segment 26/drill string. While both targeting corresponding drill pipe segments 24, 26 which are aligned along the drill string axis 18, the pairs of jaws 20, 22 are separated from one another along the drill string axis, which can allow holding two drill pipe segments 24, 26 in an end-to-end relationship.

A first task which can be performed using the drill pipe handler 10 is to pick up and move drill a drill pipe segment in position and orientation. This can involve gripping a drill pipe segment 26 around its generally cylindrical outer face and moving it once gripped, e.g., by moving the drill pipe handler 10 as a whole. A given drill pipe segment 26 can be gripped by either one of the first gripper assembly 12 or the second gripper assembly 14, or both. In a typical mode of operation, the drill pipe handler 10 can be moved in position and orientation so as to engage the drill pipe segment 26 between the open jaws 22 of a given one of the two gripper assemblies 12, 14, aligning the drill string axis 18 of the drill pipe handler 10 with the central axis of the drill pipe segment 26 (e.g., the axis of the cylindrical shape of the drill pipe segment 26), and then closing the jaws onto the external cylindrical surface of the drill pipe segment 26.

In a first mode of closing the jaws or the first pair 20 or second pair 22, which will be referred to as a tight hold, the jaws are closed in a manner to apply a certain amount of mechanical force to the external surface of the drill pipe segment, preventing not only movement of the drill pipe segment transversally to the drill string axis 18, but also rotation of the drill pipe segment around the drill string axis 18 and longitudinal movement of the drill pipe segment along the drill string axis 18. In a second mode of closing the jaws, which will be referred to as a loose hold, the jaws are closed closely to the external surface of the drill pipe segment but no pressure is applied. This limits the movement of the drill pipe segment transversally to the drill string axis 18, while allowing rotation of the drill pipe segment around the drill string axis 18 and longitudinal sliding of the drill pipe segment along the drill string axis 18.

Moving drill pipe segments 24, 26 is typically performed while gripping the drill pipe segment 26 using the tight hold mode. The drill pipe handler 10 can then be moved by the machinery 100, moving the gripped drill pipe segment 24 with it from that point onwards. The drill pipe handler 10 can be moved so as to bring the drill string axis 18 in coincidence with the rotation axis of the drill string (e.g., the central axis of the first drill pipe segment 24 which forms part of the drill string), and to bring the first drill pipe segment 24 into the spacing between the jaws of the first pair 20, and to bring the drill pipe segment 26 held by the second pair of jaws 22 adjacent the free end of the first drill pipe segment 24 (e.g. free end of the drill string which may include a single drill pipe segment or a plurality of drill pipe segments threaded to one another). Once positioned, the second drill pipe segment 26 can be engaged to the first drill pipe segment 24 (i.e., the drill string) by a threaded engagement between a male thread and a female thread. The male thread can be at the free end of the drill pipe segment 24 and the female thread at the corresponding end of the drill pipe segment 26, or vice versa, depending on the type of drill pipe segment being handled. This latter operation can be facilitated by holding the second drill pipe segment 26 in the loose hold mode, e.g., while the second gripper assembly 14 loosens its grip on the drill pipe segment 26, allowing it to rotate around the drill string axis and move longitudinally based on the pitch of the thread. This latter operation can be performed manually, or using a rotary ability of the drill pipe handler 10, an example of which will be detailed below, in which latter case it can represent a second potential task of the drill pipe handler 10.

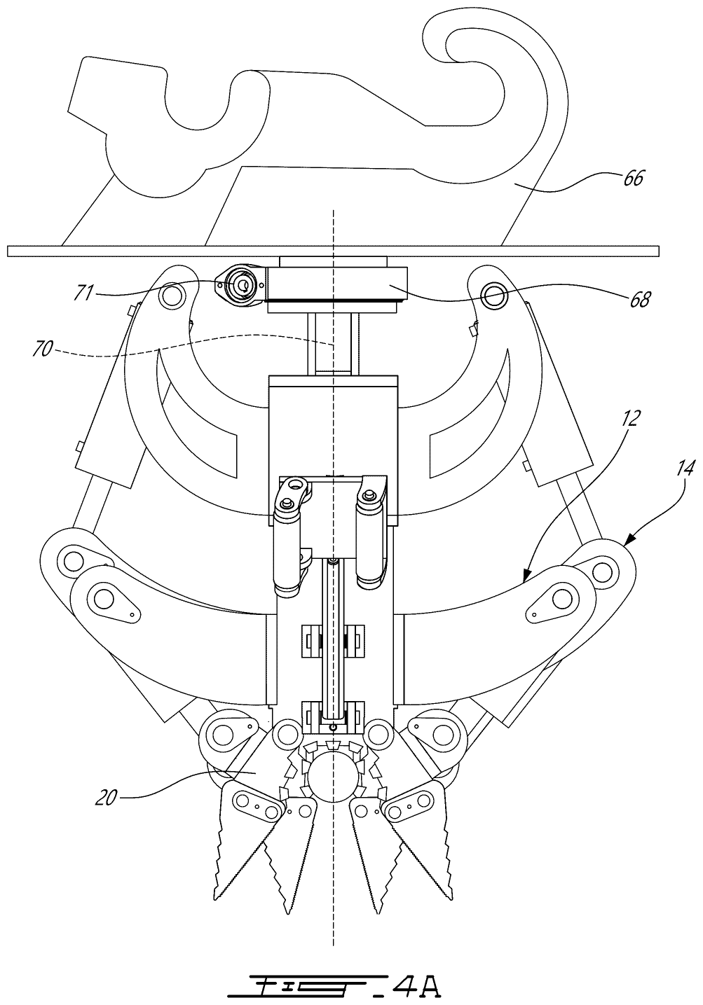

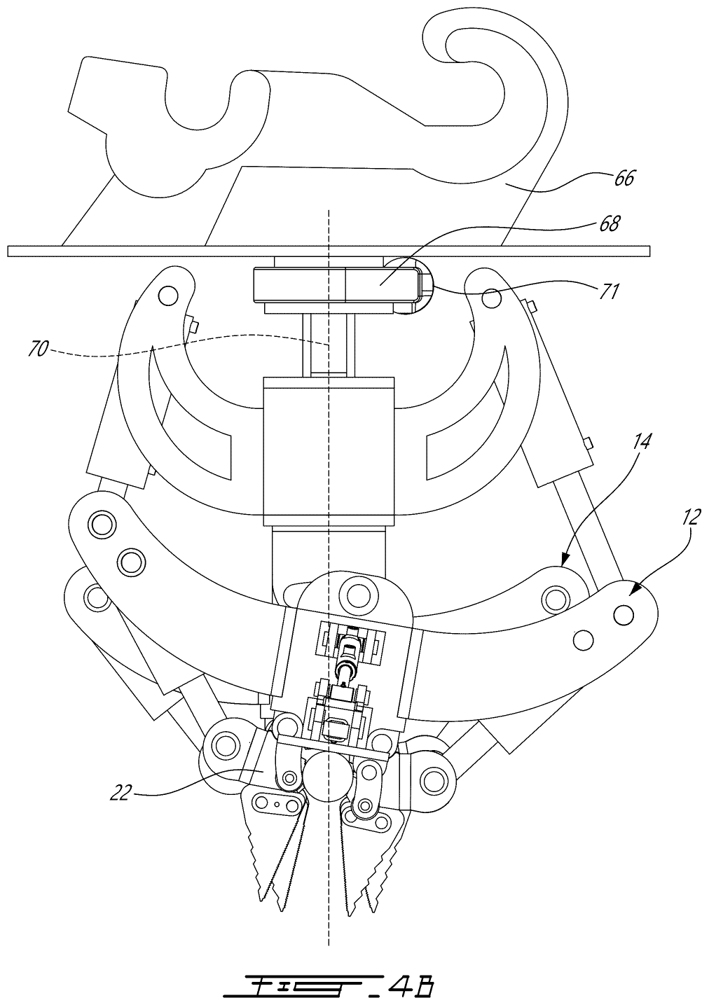

In some embodiments, it can be convenient for the drill pipe handler 10 to subject the free end of the drill string, e.g., first drill pipe segment 24, to a tight hold using the other gripper assembly 12 while performing the male-female thread engagement between the free end of the drill string and the second drill pipe segment 26. In such embodiments, the step of moving the drill pipe segment 26 into position and orientation relative the drill string can include engaging the free end of the drill string between the pair of jaws 20 of the other gripper assembly 12, a configuration which is shown in FIG. 4A. Once the drill pipe handler 10, together with the gripped drill pipe segment 26 are in position and orientation relative the free end of the drill string, the pair of jaws 20 of the other gripper assembly 12 can be closed onto the external surface of the drill pipe segment 24 at the free end of the drill string into a tight hold.

The inverse operation of moving a drill pipe segment away from the drill string can be performed in a similar, but inverse manner, i.e., moving the drill pipe handler 10 to position and orientation, at which point the last drill pipe segment 26 in the drill string can be held by the second gripper assembly 14 and the second to last drill pipe segment 24 in the drill string can be held by the first gripper assembly 12 for instance, undoing the threaded engagement between the two drill pipe segments 24, 26, releasing the drill string (e.g., drill pipe segment 24) from the first gripper assembly 12, and then moving the drill pipe segment 26 held in the second gripper assembly 14 away from the drill string. As noted above, the step of undoing the threaded engagement can require a greater application of torque, at least initially, than the step of doing the threaded engagement, because drill pipe segments may, and typically do, come into a friction fit in the drill string during the drilling operation which typically occurs between the steps of assembling and disassembling the drill string. The application of such greater torque can be a task which can be performed by the drill pipe handler 10. One example way of performing this potential task will now be explained.

Both gripper assemblies 12, 14 are mounted to the common component referred to herein as a core frame 16. In this example, the second gripper assembly 14 if different from the first gripper assembly 12, as better seen in FIGS. 3B and 3C. More specifically, the second pair of jaws 22 is pivotable around the drill string axis 18, as a whole, relative to both the core frame 16 and the first pair of jaws 20, whereas the first pair of jaws 20 is not provided with such a pivoting ability in this example. It will be noted here that the pivoting movement of the second pair of jaws 22 occurs relative to the drill string axis 18, in a context where the drill string axis 18 is spaced apart from the core frame 16. This is different from, pivoting around an axis coinciding with the core frame 16 itself. Such a pivoting movement around the drill string axis 18 can be performed via an arcuate guide.

In this embodiment, the arcuate guide is provided in the form of an engagement between a shaft and an arc-shaped slot 30 provided at a mounting point between the second gripper assembly 14 and the core frame 16. The arc shape of the arc-shaped slot 30 can be centered on the drill string axis 18. Accordingly, while the second gripper assembly 14 exerts a tight hold on a corresponding drill pipe segment 26 aligned with the drill string axis 18, the second gripper assembly 14 can pivot around the drill string axis 18, as the shaft moves along the arc-shaped slot 30.

The second gripper assembly 14 is presented in the pivoted configuration in FIG. 4B. By powering this pivoting with actuators, and performing the pivoting action of the second gripper assembly 14 relative the core frame 16 and first gripper assembly 12 while both gripper assemblies 12, 14 are engaged to adjacent drill pipe segments 24, 26, a level of torque sufficient to overcome the static friction in the threaded engagement between the drill pipe segments can be applied. Once the initial static friction in the threaded engagement has been overcome in such manner, the holding of the last drill pipe segment 26 by the corresponding jaws 22 can be loosened and the last drill pipe segment 26 can be rotated to fully undo the threaded engagement using a significantly lower amount of torque.

In this embodiment, the arc-shaped slot 30 is made integral to the core frame 16 whereas the shaft is made integral to the second gripper assembly 14, but it will be understood that in an alternate embodiment, the arc-shaped slot can equivalently be made integral to the second gripper assembly and the shaft can be made integral to the core frame. In an alternate embodiment, both gripper assemblies 12, 14 may be pivotable in such a manner, though this may not always be required to perform the task of overcoming the frictional engagement when disassembling the drill string.

In this embodiment, the task of threadingly engaging and threadingly disengaging the two last drill pipe segments of the drill string to one another or from one another can further be assisted by the drill pipe handler 10. In this example, the drill pipe handler 10 further has rotator assemblies 32, 34. More specifically, a first rotator assembly 32 is mounted to a body 36 of the first gripper assembly 12 and a second rotator assembly 34 is mounted to a body 38 of the second gripper assembly 14. As can be understood by comparing the configurations of the first segment rotator assembly 32 and of the second segment rotator assembly 34 in FIG. 2, each rotator assembly 32, 34 can be operated to pivot, relative the body 38, 36 of the corresponding gripper assembly 12, 14, into and out from engagement with a drill pipe segment 24, 26 gripped by the corresponding gripper assembly 12, 14. Each rotator assembly 32, 34 can have rotary cylinders 40 frictionally engageable against the external surface of the corresponding drill pipe segment 26, 24, one or more of which can be “driven” in the sense that it can be operable to drive the rotation the corresponding drill pipe segment 24, 26, over one or more full rotations for instance. Accordingly, one of the rotator assemblies 32, 34 can be operated in a manner to fully engage or fully disengage the threaded engagement while the corresponding gripper assembly 12, 14 loosely holds the corresponding drill pipe segment 26.

While a rotator assembly may not be configured to impart sufficient torque to overcome the initial static friction fit between two adjacent drill pipe segments subsequently to a drilling operation, it may be configured to impart sufficient torque to continue the rotary movement of the drill pipe segment 26 and fully undo the threaded engagement with the drill pipe segment 24 once the initial static friction has been overcome, and it may be able to do so conveniently over a greater angular displacement than the maximum amount of pivoting of the gripper assembly. Accordingly, in one embodiment, the pivoting action of the second gripper assembly 14 can be used to overcome the initial static friction engagement between the last drill pipe segment 26 and the second-to-last drill pipe segment 24, and once the initial static friction engagement has been overcome, the segment rotator assembly 34 can be used to continue the thread disengagement until the last drill pipe segment 26 becomes fully disengaged from the drill string. It will be noted that while in this embodiment, two rotator assemblies 32, 34 were provided for convenience, an alternate embodiment may have only one rotator assembly, or no rotator assembly at all, the latter being an option. Moreover, while in this embodiment, the rotator assemblies 32, 34 are articulated in a manner to be pivotable relative the corresponding bodies 36, 38 of the gripper assemblies 12, 14, and are thus deployable or retractable, in an alternate embodiment, a rotator assembly may be non-articulated.

As mentioned above, there can be a motivation to adapt the drill pipe handler 10 to different diameters of drill pipe, since the drill pipe diameter can vary from one job to another. In particular, it is relatively common for drill pipe to be below 16 inches in diameter. In the example illustrated, the jaws are configured for manipulating drill pipe segments of up to 12 inches in diameter, but in alternate embodiments, the jaws are adapted to larger diameters. There is no hard inferior limit to the diameter of drill pipe segments to which the jaws are to adapt to, but it will be understood that static friction in the threaded engagement between drill pipe segments rarely poses a significant issue for drill pipe segments having 3 inches or less in diameter. While drill pipe having 3 inches or less may still be handled by the drill pipe handler, the torsioning function of the drill pipe handler 10 which overcomes the static friction fit by the pivoting of the second pair of jaws relative the first pair of jaws may not be needed as much as in the case of larger diameters. Accordingly, in an embodiment, jaws can be configured for engaging drill pipe segments having a diameter between 4 inches and 16 inches for instance.

One way to adapt the jaws to different diameters is to use more than one set of first pair of jaws, and more than one set of second pair of jaws, with different ones of the sets being specifically adapted to different diameters of drill pipe. In such an embodiment, the drill pipe handler can be adaptable to a different diameter of drill pipe by removing the first pair of jaws and the second pair of jaws, and replacing them by another set of first pair of jaws and of second pair of jaws, respectively, with the other sets being adapted to a different diameter than the initial sets. While such a solution can be deemed convenient in some embodiments, it may be deemed cumbersome in others.

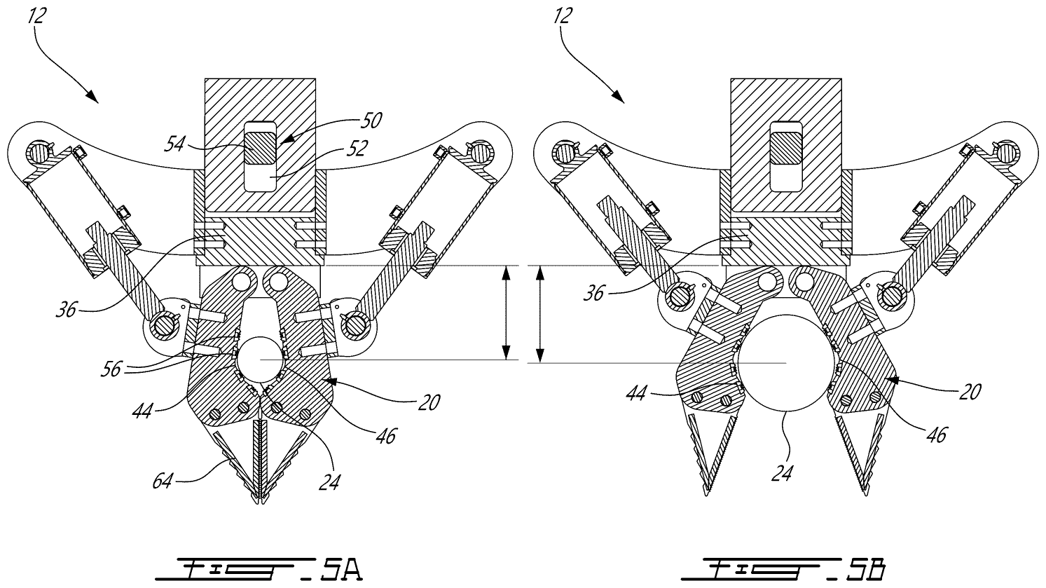

A different approach to adapting the jaws to different diameters of drill pipe is used in the embodiment illustrated, and which will now be explained with reference to FIG. 5A. As shown in FIG. 5A, the internal faces of the jaws of each pair of jaws can have V-shaped surface 44, 46. The V-shaped surface 44, 46 can provide the function of biasing the drill pipe of different diameters with the center of the V-shapes (i.e. auto-centering), and ensuring a good contact independently of the diameter of the drill pipe. It will be noted that while the drill pipe segments of different diameters can suitably be handled by pairs of jaws having such V-shaped surfaces 44, 46, the exact distance between the center of the drill pipe segment 24 held by the pair of jaws 20 (which center coincides with the center of the V-shaped internal surfaces) and the body 36 to which the jaws are pivotally mounted, will vary to a certain extent based on the change in diameter.

Since the center of the drill pipe segment 24 held by the pair of jaws 20 coincides with the drill string axis 18 of the drill pipe handler 10, the exact position of the drill string axis 18 of the drill pipe handler 10, relative the core frame 16, can be said to vary to a certain extent based on the diameter of the drill pipe segments in this embodiment. Referring back to FIG. 2, when the first pair of jaws 20 and the second pair of jaws 22 hold drill pipe segments 24, 26 of the same diameter, the central axis of both drill pipe segments 24, 26 coincide with a unique drill string axis 18. However, when the first pair of jaws 20 and the second pair of jaws 22 hold drill pipe segments 24, 26 of different diameters, the central axis of both drill pipe segments 24, 26 may be offset from one another, which may result in a misalignment between a drill pipe segment 26 and the drill string. The latter effect may be deemed irrelevant in the case of drill pipe handler embodiments adapted to handle drill pipe segments of drill strings having a constant diameter, but may be deemed inconvenient in the case of drill pipe handler embodiments meant to handle drill strings having variable diameters (e.g., drill strings having more than one diameter of drill segment). To overcome this latter challenge, the embodiment illustrated is provided with a first gripper assembly 12 which has a pair of jaws 20 which can be moved towards or away from the core frame, via an optional sliding ability of the body 36.

More specifically, as shown in FIG. 5A, a linear guide 50 can be provided between the body 36 of the first gripper assembly 12 and the core frame 16. In this embodiment, the linear guide 50 can have a linear slot 52 extending normal to the drill string axis 18 towards the core frame 16, and a shaft 54. The linear slot 52 can be made integral to the body 36 of the first gripper assembly, whereas the shaft 54 can be made integral to the core frame 16, or vice versa. This can allow to achieve a better transversal alignment of both pairs of jaws 20, 22 with the drill string axis 18 when the drill pipe segments 24, 26 held respectively by the two pairs of jaws 20, 22 have different diameters, more specifically by adapting the location of the central axis of the first drill pipe segment 24 to the central axis of the second drill pipe segment 26. This can allow maintaining the central axis of two adjacent drill pipe segments 24, 26 having different diameters and held by respective pairs of jaws 20, 22 aligned with one another and coinciding with the drill string axis 18. In an alternate embodiment, the longitudinal sliding ability can be integrated to the second gripper assembly rather than in the first gripper assembly. In this embodiment, carbon inserts 56 are also used on each one of the two faces of each V-shaped surface to promote suitable gripping ability of the jaws.

Depending on the embodiment, while the jaws may be designed to adapt to different diameters, the specific subset of diameters to which the jaws are to be adapted to may be known. For instance, it may be known that the jaws are to adapt to 3.5″, 6⅝″, 10¾″ and 12¾″ drill pipe in one specific example embodiment. In such cases, the location of the carbon inserts 56 within the V shaped surfaces 44, 46 may be engineered in a manner to offer a point of contact with drill pipe of any one of the diameters forming part of the subset to which it is designed to adapt to. In FIG. 5A, for instance, it can be seen that when handling a first drill pipe segment having a first, small diameter, a first set of 4 carbon inserts are in contact with the drill pipe segment, whereas as shown in FIG. 5B, when the same gripping assembly is used to grip a drill pipe segment having a second, larger diameter, a second set of 4 carbon inserts are in contact with the drill pipe segment. The carbon inserts can be used to ensure a sufficiently tight grip to satisfactorily achieve the torsioning function associated to overcoming static friction upon disassembly.

In this example, the pairs of jaws 20, 22 are provided with extensions which will be referred herein as pinching tips 64. The pinching tips 64 are roughly of triangular shape in this example and are provided with rugged external edges. The pinching tips 64 can be convenient for more finely manipulating items than the jaws would otherwise allow, especially with smaller or thinner items. Moreover, while the pinching tips may be used to pinch items externally, they can also be introduced into the opening of a hollow item such as the open end of a tubular object, and opened inside against the opposed internal surfaces, allowing to hold such a hollow item from inside.

In the embodiment presented in the figures, a coupler 66 is provided as part of the drill pipe handler 10 to allow additional convenience in the coupling and uncoupling of the drill pipe handler 10 to the machinery 100 used to manipulate it. Of course, in an embodiment where the drill pipe handler is integrated to dedicated machinery, such a coupler 66 may be omitted and may not be needed. Independently of whether a coupler 66 is integrated to the drill pipe handler or not, a rotary joint 68 may be incorporated to the drill pipe handler 10 between the machinery 100 and the core frame 16, to allow rotating the gripping assemblies 12, 14 as a whole relative the machinery. In an embodiment having a coupler 66, such as the one illustrated, the rotary joint 68 can be provided between the coupler 66 and the core frame 16 for instance. The rotary joint 68 can have a rotation axis 70 which is normal to the drill string axis. A rotary motor 71 can be used to drive the rotation of the rotary joint 68. In this specific example, since the drill pipe handler 10 is configured for use on an excavator, the coupler 66 can be specifically adapted to engage an excavator H-link.

In this example, the movement of the different parts of the drill pipe handler 10 can be hydraulically powered, for instance, though this is optional and other types of actuators may be used in alternate embodiments. In this specific example, a first pair of actuators 58, provided here in the form of hydraulic cylinders can control the opening and closing of first gripper assembly 12, a second pair of actuators 60, provided here as hydraulic cylinders can control the opening and closing of the second gripper assembly 22, and a third pair of actuators 62, provided here as hydraulic cylinders can control the pivoting of the second pair of jaws 22 relative the first pair of jaws 20. It will be noted that while in this embodiment, a pair of actuators 62 is used to control the pivoting of the second gripper assembly 14 relative the first gripper assembly 12, a single actuator may be used instead of a pair in an alternate embodiment. Moreover, while pairs of actuators 58, 60 are used to control the opening and closing of the pairs of jaws 20, 22 of the gripper assemblies 12, 14, an alternate embodiment may use a single actuator and a linkage instead of a pair of actuators, for instance. For instance, a hydraulic motor can be used as a rotation motor 71, to rotate the drill pipe handler 10 around a rotation axis 70 relative the machinery 100.

In the case of embodiments for which movement is hydraulically powered, there may be a single hydraulic connection between a valve block and the machinery 100. The valve block may have a number of electrically powered valves connecting different ones of the hydraulic cylinders or hydraulic motor. An electrical connection, e.g. 12V or 24V for instance, may be provided between the machinery and the valve block. A controller may be provided with a wireless or wired connection to the valve block, to allow an operator to remotely control individual ones of the valves of the valve block with a single controller, and thereby control the motion of the different movable parts of the drill pipe handler remotely, at a safe distance from the drill pipe segments and drill string.

FIG. 3A presents the core frame 16 of the example embodiment in greater detail. In this example, the core frame 16 has generally box-shaped structural element to which the first gripper assembly 12 and second gripper assembly 14 can be mounted to. The box-shaped support element can further bear a guide having the arc-shaped slot 30. The arc-shaped slot 30 can allow the pivoting of the second pair of jaws 22 relative core frame 16 while preventing the second gripper assembly 12 from being moved towards or away from the core frame 16, for instance. In this embodiment, the core frame 16 has laterally and upwardly extending support arms 72. These support arms 72 provide, at their distal end, an attachment point for corresponding actuators (e.g. hydraulic cylinders when the drill pipe handler is hydraulically powered), which can drive the pivoting of the second gripper assembly 14 around the drill pipe axis 18 (i.e., the guided sliding of its shaft along the arc-shaped slot). In this example, the pair of support arms 72 made integral to the core frame 16 are horn shaped and curve upwardly to provide good mechanical resistance with relatively low weight.

FIG. 3B presents the first gripper assembly 12 of this example in greater detail. The first gripper assembly 12 can also be seen to have a body 36 and a pair of laterally extending support arms 74. The body 36 of the first gripper assembly 12 can be seen to have an obround cross-sectional shape, with two flat sides from which the support arms 74 extend. The support arms 74 provide, at their distal end, an attachment point for corresponding actuators 58. The first gripper assembly 12 has a first pair of jaws 20. Each jaw has, on its external face, an attachment point for corresponding actuators. The opening and closing of the first pair of jaws 20 can be driven by the extension and retraction of the corresponding actuators 58. It will be noted that in this specific embodiment, the first pair of jaws 20 can extend and retract relative the core frame 16. These latter features are optional, and their purpose will be explained further below.

FIG. 3C presents the second gripper assembly 14 of this example in greater detail. The second gripper assembly 14 can also have a body 38 and a pair of laterally extending support arms 76. The body 38 of the second gripper assembly 14 can also be seen to have an obround cross-sectional shape, with two flat sides from which the support arms 76 extend. The support arms 76 provide, at their distal end, two attachment points for corresponding actuators 62, 60. The second gripper assembly 14 has a second pair of jaws 22. Each jaw has, on its external face, an attachment point for a corresponding actuator 60. The opening and closing of the second pair of jaws 22 can be driven by the extension and retraction of a first set of actuators 60 configured to extend or retract between the attachment point of the corresponding jaws and a first of the attachment points of the support arms 76. The pivoting of the second gripper assembly 14 around the drill pipe axis 18 can be driven by a second set of actuators 62 configured to extend or retract between the attachment point of the core frame 16 and the second attachment point of the support arms 76. Accordingly, in this example where only the second gripper assembly 14 pivots, the support arms 76 of the second gripper assembly 14 are longer than the support arms 74 of the first gripper assembly 12 and carry additional pivots. The third set of actuators 62 can be mounted between a corresponding one of these additional pivots and a corresponding pivot provided in a pair of support arms 72 made integral to the core frame 16 (see FIG. 3A).

It will be noted here that the pairs of actuators presented can be equivalently replaced by single actuators in certain embodiments. In the case of the gripping jaws, this may be done by adding a mechanical linkage between the jaws to maintain the jaws centered around the drill string axis. In the case of the actuators driving the pivoting of the second gripper assembly, the second actuator, and the associated support arm protruding from the core frame, are entirely optional and can be provided solely for the purpose of providing additional torque. The second actuator, if used, can be hydraulically connected in an inverse manner such as to retract when the first one extends, and vice-versa, in the specific example context of a hydraulically powered embodiment.

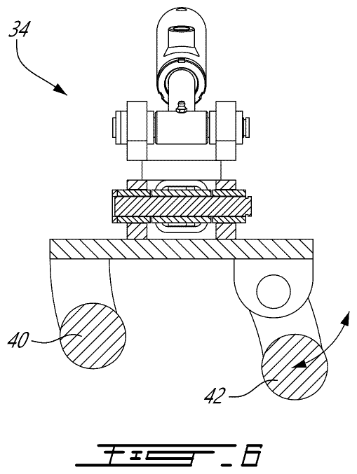

An example configuration of a rotator assembly 34 which was used in this specific embodiment is presented in greater detail in FIG. 6. In this example, two rotary cylinders 40, 42 are used, one 42 of which is hingedly mounted around an axis which is parallel to it's axis of rotation so as to accommodate different diameters of drill pipe segments. Either one, or both, of the rotary cylinders can be hydraulically driven for instance. The pivoting action can also by hydraulically powered or spring biased, for instance.

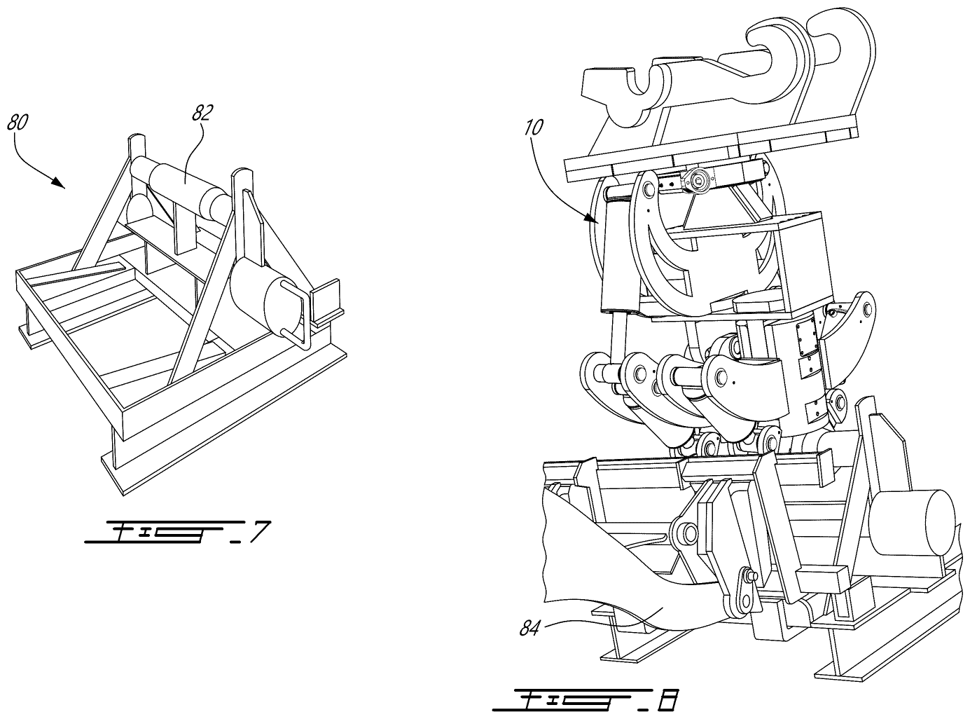

FIG. 7 shows a drill pipe handler rack 80 having a support pipe 82 to which the first and second sets of jaws 20, 22 of the drill pipe handler 10 can be engaged when the drill pipe handler 10 is not in use. FIG. 8 shows the drill pipe handler 10 of FIG. 1 uncoupled from the machinery 100, and mounted to the rack 80. As shown in FIG. 8, the rack 80 can be configured for manipulation by a forklift 84.

As can be understood, the examples described above and illustrated are intended to be exemplary only. In an alternate embodiment, there can be more than two gripper assemblies. In an alternate embodiment, two or more gripper assemblies can be pivotable rather than only the second gripper assembly. The drill pipe handler can be used with different types of machinery such as a tractor, a lift, a telescopic handler, a loader or a crane, amongst possibly other types of suitable machinery. The scope is indicated by the appended claims.

What is claimed is:

1. A drill pipe handler comprising:
a core frame;
a drill string axis;
a first gripper assembly mounted to the core frame, the first gripper assembly having a first pair of jaws, the jaws of the first pair being opposed to one another, on opposite sides of the drill string axis; and
a second gripper assembly mounted to the core frame, the second gripper assembly having a second pair of jaws, the jaws of the second pair being opposed to one another, on opposite sides of the drill string axis, the jaws of the second pair being spaced apart from the jaws of the first pair along the drill string axis, the second pair of jaws being pivotable as a whole around the drill string axis, relative the first pair of jaws.

2. The drill pipe handler of claim 1 wherein the first gripper assembly has a body connecting the first pair of jaws to the core frame, the jaws of the first pair pivotable individually relative the body of the first gripper, and wherein the second gripper assembly has a body pivotable around the drill string axis, the gripper jaws of the second pair individually pivotally mounted to a distal end of the body of the second gripper, a proximal end of the body of the second gripper being slidably mounted to the core frame via an arcuate guide, the arcuate guide being concentric to the drill string axis.

3. The drill pipe handler of claim 2 further comprising a first actuator extendible and retractable between a first pivot point integral to the core frame and a first pivot point integral to the body of the second gripper, the first actuator driving the pivoting of the second pair of jaws.

4. The drill pipe handler of claim 3 further comprising a second actuator extendible and retractable between a second pivot point integral to the core frame, laterally opposite the first pivot point integral to the core frame, and a second pivot point integral to the body of the second gripper, laterally opposite the first pivot point integral to the body of the second gripper, the second actuator collaborating with the first actuator in driving the pivoting of the second pair of jaws.

5. The drill pipe handler of claim 4 wherein the first and second pivot points integral to the core frame are positioned at a distal end of corresponding support arms protruding from the core frame laterally opposite from one another and away from the drill string axis.

6. The drill pipe handler of claim 4 wherein the first and second pivot points integral to the body of the second gripper are positioned at a distal end of corresponding support arms protruding from the core frame laterally opposite from one another.

7. The drill pipe handler of claim 2 further comprising a first pair of actuators extendible and retractable between a corresponding pair of pivot points integral to the body of the first gripper and corresponding pair of pivot points integral to the jaws of the first pair, and a second pair of actuators extendible and retractable between a corresponding pair of pivot points integral to the body of the second gripper and a corresponding pair of pivot points integral to the jaws of the second pair.

8. The drill pipe handler of claim 2 wherein the body of the first gripper assembly is extendible relative the core frame.

9. The drill pipe handler of claim 8 further comprising a linear guide between the first gripper assembly and the core frame.

10. The drill pipe handler of claim 1 wherein at least one of the jaws of the first pair and the jaws of the second pair each have a V shaped internal surface wherein the open end of the V shaped internal surface faces the drill string axis.

11. The drill pipe handler of claim 10 the V shaped internal surfaces each have least a first set of carbon inserts at a first distance from a corner of the V shaped internal surface and adapted to engage a drill pipe segment of a first diameter, and a second set of carbon inserts at a second distance from the corner of the V shaped internal surface and adapted to engage a drill pipe segment of a second diameter.

12. The drill pipe handler of claim 1 further comprising a coupler configured to mount the drill pipe handler to machinery.

13. The drill pipe handler of claim 12 further comprising a rotary joint between the coupler and the core frame, the rotary joint operable to rotate the core frame relative the coupler around an axis normal to the drill string axis.

14. The drill pipe handler of claim 13 further comprising a hydraulic motor operable to rotate the coupler relative the core frame via the rotary joint.

15. The drill pipe handler of claim 1 further comprising hydraulic cylinders for opening and closing the first pair of gripper jaws, the second pair of gripper jaws, and for pivoting the second gripper assembly around the drill string axis.

16. The drill pipe handler of claim 1 further comprising at least one pair of pinching tips protruding from corresponding ones of the jaws of the first pair or the jaws of the second pair, the pinching tips being closable and openable by closing and opening the corresponding jaws, and being narrower than the corresponding jaws.

17. The drill pipe handler of claim 1 further comprising at least one rotator assembly secured to a corresponding one of the first gripper assembly and the second gripper assembly, wherein the rotator assembly is engageable with a pipe segment loosely held by the corresponding one of the first gripper and the second gripper.

18. The drill pipe handler of claim 17 wherein the rotator assembly is pivotable into and out from said engagement.

19. The drill pipe handler of claim 17 wherein the rotator assembly is secured to the second gripper assembly.

20. The drill pipe handler of claim 1 provided in combination with a drill pipe handler rack having a support pipe operable to be gripped by the first pair of jaws and the second pair of jaws, and forklift apertures operable to be engaged by a forklift.
